(19) United States
(12) Patent Application Publication
(10) Pub. No.: US 2017/0289235 A1
(43) Pub. Date: Oct. 5, 2017

(54) Recipient-Based Content Sharing

(71) Applicant: Microsoft Technology Licensing, LLC, Redmond, WA (US)

(72) Inventors: Gregory Thomas Mattox, JR., Bellevue, WA (US); Shane Michael Chism, Bellevue, WA (US); Nikhil N. Gaekwad, Bellevue, WA (US); Brenda WY Bell, Bellevue, WA (US); Paula Julia Chuchro, Seattle, WA (US)

(73) Assignee: Microsoft Technology Licensing, LLC, Redmond, WA (US)

(21) Appl. No.: 15/084,213

(22) Filed: Mar. 29, 2016

(51) Int. Cl. H04L 29/08; G06F 3/0486; G06F 3/0484; H04L 12/26; G06F 3/0482

(52) U.S. Cl. CPC H04L 67/06; H04L 67/10; H04L 67/22; H04L 69/326; H04L 43/06; H04L 67/24; G06F 3/0482; G06F 3/04842; G06F 3/0486

(57) ABSTRACT

Techniques and apparatuses for recipient-based content sharing are described herein. In one or more implementations, input to share content with a recipient is detected. In response to detection of the input, a communication transport for sharing the content with the recipient is determined based at least in part on history of sharing the content with the recipient or a type of the content. The communication transport may be automatically selected from a plurality of communication transports based on the sharing history. For example, the communication transport may be selected based on being the “last used” or “most frequently used” communication transport utilized to share content with the particular recipient. Alternately, a list of suggested communication transports may be presented to the user to enable selection of the communication transport from the list. The content is then shared with the recipient using the determined communication transport.

### BACKGROUND

Users today have access to an increasing number of different communication transports (e.g., email applications, social applications, and text messaging applications) that can be used to share content (e.g., a photo, video, or document). Current sharing solutions require the user to select the particular communication transport (e.g., an email applications) before sharing the content. However, users may utilize different communication transports to share content with different people. For example, a user may usually share content with his wife using a text messaging application, share content with his friends using his personal email account, and share content with his co-workers using his business email account. Further, users may also share content with a personally-created group of people, such as “college friends” or “parents”. Furthermore, in many cases, the user may not know the best communication transport to share content with a particular recipient. For example, a particular recipient may never respond to email, but quickly respond to text messages.

Thus, requiring the user to select the communication transport forces the user to remember which communication transport to use for different people, or predict the communication transport that is the best option for sharing content with a particular person. Furthermore, conventional solutions require the user to take multiple steps in order to share content with others. For example, to share content via email, the user may select and launch the email application, generate a new message using the email application, and then attach the content to the message.

### SUMMARY

Techniques and apparatuses for recipient-based content sharing are described herein. In one or more implementations, input to share content with a recipient is detected. The input can be received in a variety of different ways, such as user input to drag and drop a visual representation of the content proximate a visual representation of the recipient. In response to detection of the input, a communication transport for sharing the content with the recipient is determined based at least in part on history of sharing the content with the recipient or a type of the content. As described herein, a communication transport may include any type of communication transport or communication technology that can be used to communicate content, including by way of example and not limitation, messaging protocols (e.g., email applications, text messaging applications, and WhatsApp), Social Applications (e.g., Instagram®, Facebook®, Twitter®), device-to-device sharing transports (e.g., sharing directly to a device over a network or the cloud or using a nearby device application, such as Airdrop by Apple®, Bluetooth™, NFC), and so forth.

In one or more implementations, the communication transport may be automatically selected from a plurality of communication transports based on the sharing history. For example, the communication transport may be selected based on being the “last used” or “most frequently used” communication transport utilized to share content with the particular recipient. Alternately, a list of suggested communication transports may be presented to the user to enable selection of the communication transport from the list.

The content is then shared with the recipient using the determined communication transport. In one or more implementations, the content is shared by uploading the content to a remote file-sharing service, and sharing a link to the content stored at the file-sharing service with the recipient via the determined communication transport.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the following discussion.

FIG. 1 is an illustration of an environment in an example implementation that is operable to employ techniques described herein.

FIG. 2 is a flow diagram depicting an example procedure for recipient-based content sharing in accordance with one or more implementations.

FIG. 3A illustrates an example of recipient-based content sharing in accordance with one or more implementations.

FIG. 3B illustrates an additional example of recipient-based content sharing in accordance with one or more implementations.

FIG. 3C illustrates an additional example of recipient-based content sharing in accordance with one or more implementations.

FIG. 4A illustrates an additional example of recipient-based content sharing in accordance with one or more implementations.

FIG. 4B illustrates an additional example of recipient-based content sharing in accordance with one or more implementations.

FIG. 5 illustrates an example system having devices and components that may be employed to implement aspects of the techniques described herein.

### DETAILED DESCRIPTION

Overview

Recipient-based content sharing is described. Rather than requiring the user to select a particular communication transport to share content with a particular recipient, a communication transport is determined based on a history of sharing content with the recipient.

In one or more implementations, input to share content (e.g., a text-based message, a photo, a video, or a document) with a recipient is detected. The input can be received in a variety of different ways, such as input to drag and drop a visual representation of the content proximate a visual representation of the recipient. Notably, however, the input does not indicate a particular communication transport to facilitate the sharing of the content.

In response to detection of the input, a communication transport for sharing the content with the recipient is determined based at least in part on history of sharing the content with the recipient. As described herein, a communication transport may include any type of communication transport or communication technology that can be used to communicate content 108, including by way of example and not limitation, messaging protocols (e.g., email applications, text messaging applications, and WhatsApp®), Social Applications (e.g., Instagram®, Facebook®, Twitter®), device-to-device sharing transports (e.g., sharing directly to a device over a network or the cloud or using a nearby device application, such as Airdrop by Apple®, Bluetooth™, NFC), and so forth. Thus, sharing content with a recipient via a communication transport corresponds to communicating the content to an account of the recipient associated with the particular communication transport, such as the user's email address.

In some cases, the communication transport may be automatically selected for the user, from a plurality of communication transports, based on the sharing history. For example, the communication transport may be selected based on being the “last used” or “most frequently used” communication transport to share content with the particular recipient. In this way, the system is able to predict the communication transport that the user would likely use to share the content without requiring the user to remember the communication transport that is usually used to share the content with different recipients. Furthermore, automatic selection of the communication transport reduces the number of steps required by conventional solutions to share content. For example, the user may be able to simply drag and drop the content over a representation of the recipient in order to share the content with the recipient, as opposed to opening an email application, creating a new message, and attaching the content to the message.

Alternately, instead of automatically selecting the communication transport, a list of suggested communication transports may be presented to enable the user to select one of the communication transports from the list. In this way, the system suggests communication transports that can be used to share the content with the particular recipient.

The content is then shared with the recipient using the determined communication transport. In one or more implementations, the content is shared by uploading the content to a remote file-sharing service, and sharing a link to the content stored at the file-sharing service with the recipient via the determined communication transport.

Example Environment

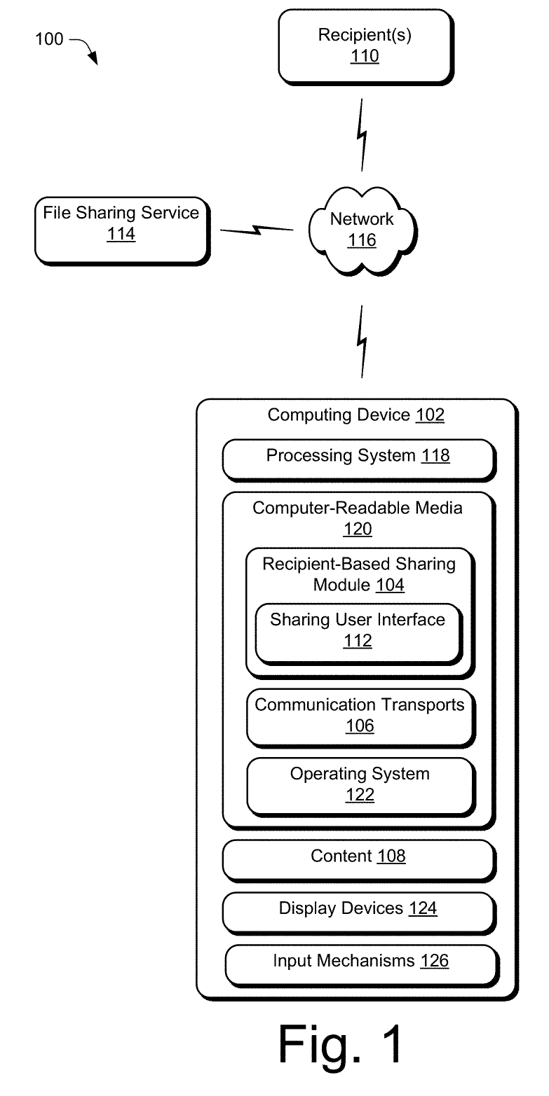

FIG. 1 is an illustration of an environment 100 in an example implementation that is operable to employ techniques described herein. The environment 100 includes a computing device 102 at which a recipient-based sharing module 104 (“sharing module”) is implemented. Generally, sharing module 104 is configured to determine a communication transport 106 for sharing a content 108 with a recipient 110. Content 108 may include any type of content, such as text-based messages, photos, videos, documents, news articles, and so forth. As described herein, communication transports 106 include any type of communication transport or communication technology that can be used to communicate content 108, including by way of example and not limitation, messaging protocols (e.g., email applications, text messaging applications, and WhatsApp), Social Applications (e.g., Instagram, Facebook, Twitter), nearby device applications (e.g., Airdrop by Apple, Bluetooth, NFC), and so forth.

As discussed in more detail below, sharing module 104 may either automatically select a communication transport 106 for sharing the content 108, or provide the user with a list of suggested communication transports 106 in a sharing user interface 112 that can be selected by the user to share the content 108. In some cases, sharing module 104 causes the content 108 to be directly communicated to the recipient 110 via the communication transport 106. Alternately, the content 108 may first be uploaded to a remote file-sharing service 114, such as OneDrive® by Microsoft®, Dropbox®, or Google Drive®, to name just a few. Then, a link to the file stored on the file-sharing service 114 may be communicated to the user via the selected communication transport 106.

Computing device 102, recipients 110, and file-sharing service 114 are communicatively coupled, one to another, via a network 116. Although network 116 is illustrated as the Internet, the network may assume a wide variety of configurations. For example, network 116 may include a wide area network (WAN), a local area network (LAN), a wireless network, a person area network (PAN), a public telephone network, an intranet, and so on. Further, although a single network 116 is shown, network 116 may also be configured to include multiple networks.

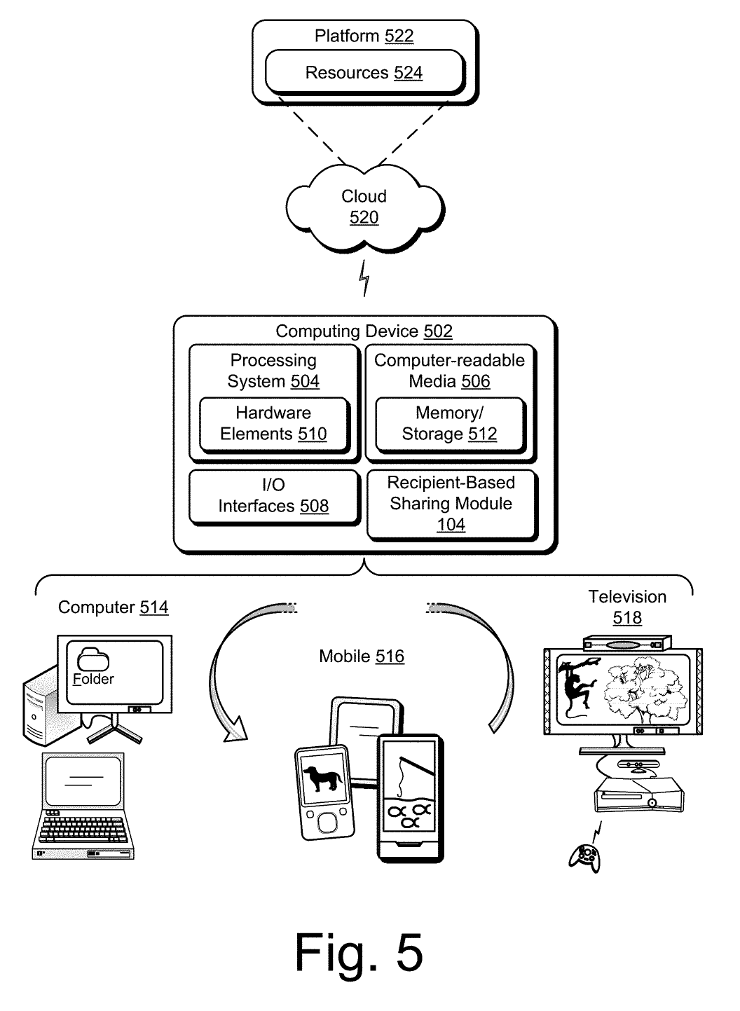

Computing devices that implement the computing device 102, recipient 110, or file-sharing service 114 may be configured in a variety of different ways. A computing device, for instance, may be configured as a desktop computer, a laptop computer, a mobile device (e.g., assuming a handheld configuration such as a tablet or mobile phone), a wearable device (e.g., a smartwatch, smart glasses, or fitness band), stand-along computing device (e.g., Amazon Echo), virtual reality or holographic devices (e.g. HoloLens), and so forth. Thus, a computing device may range from full resource devices with substantial memory and processor resources (e.g., personal computers, game consoles) to a low-resource device with limited memory and/or processing resources (e.g., mobile devices). Additionally, although a single computing device is described in some instances, the computing device may be representative of a plurality of different devices, such as multiple servers utilized by a business to perform operations “over the cloud” for the sharing module 104, further discussion of which may be found in relation to FIG. 5.

In the illustrated example, the computing device 102 includes a processing system 118 having one or more processing devices and computer-readable media 120 configured to implement various application programs, modules, logic, and/or device functionality. For instance, the computer-readable media 120 may include an operating system 122, as well as sharing module 104 and its associated sharing user interface 112, and communication transports 106.

The computing device 102 additionally may include or otherwise make use of one or more display devices 124 and input mechanisms 126. Display devices 124 may be separate or integrated with the computing device 102. Input mechanisms 126 may include gesture-sensitive sensors and devices, such as touch-based sensors and movement-tracking sensors (e.g., camera-based), as well as mice (free-standing or integral with a keyboard), a stylus, touch pads, accelerometers, and microphones with accompanying voice recognition software, to name a few. Input mechanisms 126 may be separate or integrated with displays device 124. Integrated examples may include gesture-sensitive displays with integrated touch-sensitive or motion-sensitive sensors.

The operating system 122 manages resources of the computing device 102 and may be implemented using any suitable instruction format, such as 64-bit, 32-bit, reduced instruction set computing (RISC), complex instruction set computing (CISC), and the like. The operating system is configured to abstract underlying functionality of the underlying device to applications that are executable on the computing device. For example, the operating system 122 may abstract processing, memory, network, and/or display functionality such that the applications, such as sharing module 104, may be written without knowing “how” this underlying functionality is implemented. The applications, for instance, may provide data to the operating system to be rendered and displayed by a display device without understanding how this rendering will be performed. A variety of applications typically associated with client devices are contemplated including, but not limited to, a productivity suite that integrates multiple office productivity modules, a web browser, games, a multi-media player, a word processor, a spreadsheet program, a photo manager, and so forth.

Any or all of sharing module 104, communication transports 106, and operating system 116 may be implemented as separate components or combined or integrated together in different combinations in any suitable form.

Recipient-Based Content Sharing

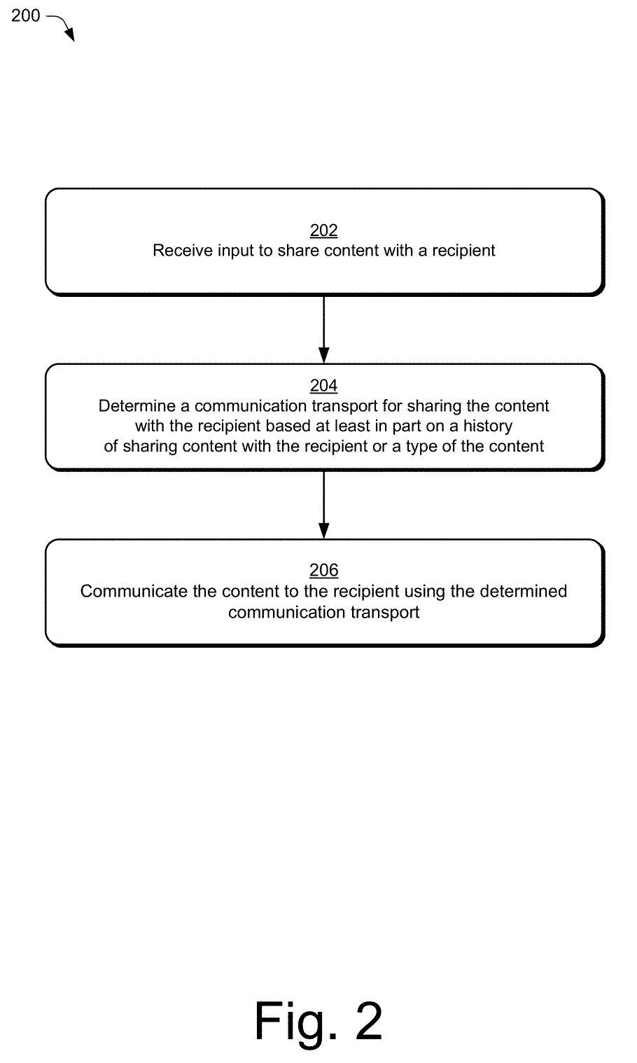

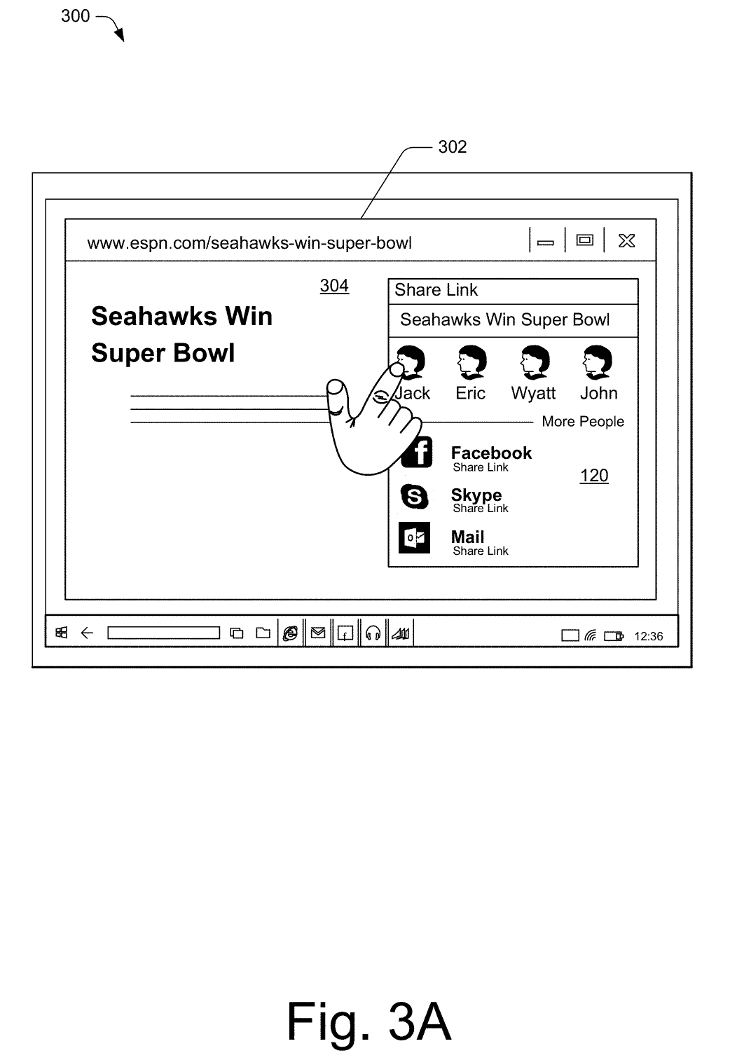

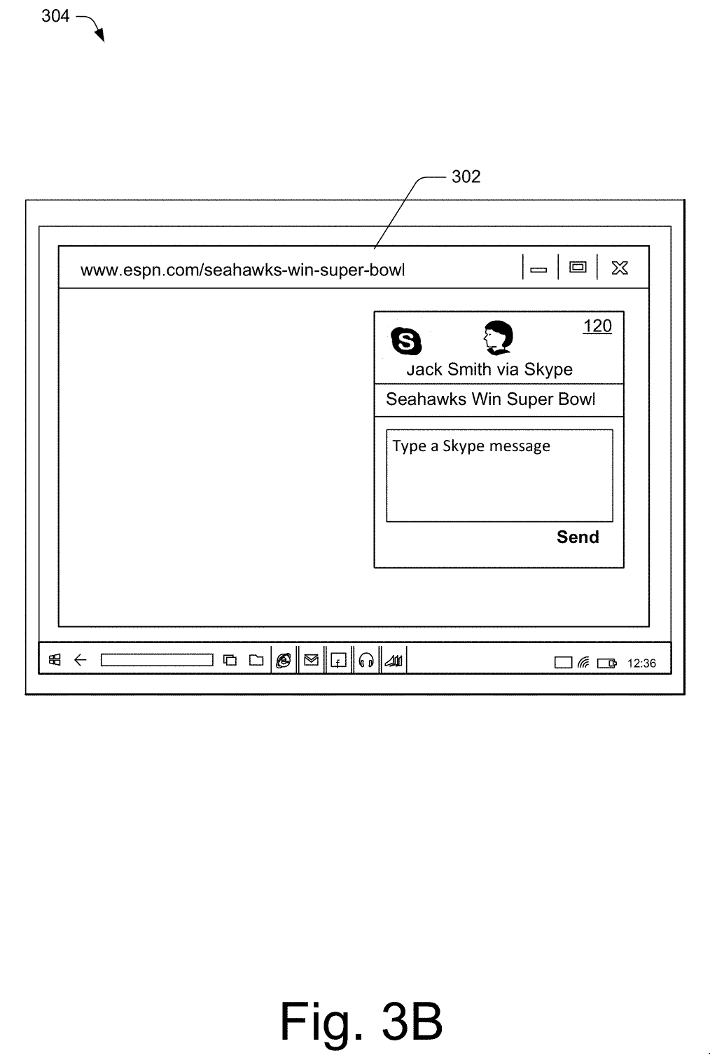

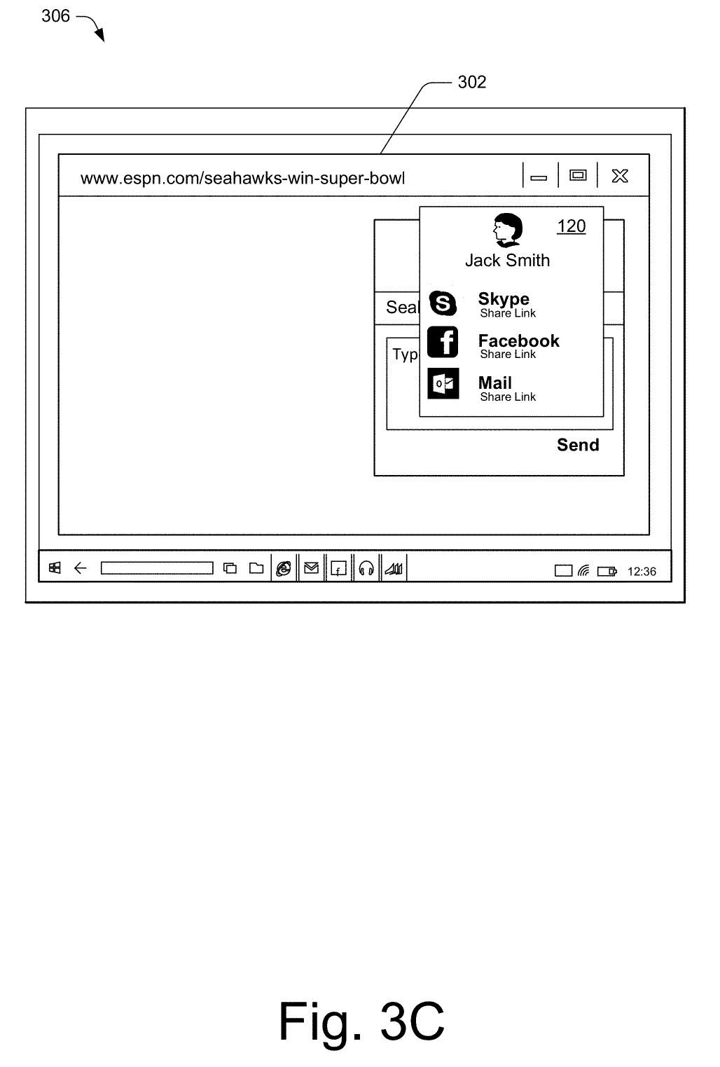

The following discussion describes techniques that may be implemented utilizing the previously described environment. Aspects of the procedure may be implemented in hardware, firmware, or software, or a combination thereof. The procedure is shown as a set of blocks that specify operations performed by one or more devices and are not necessarily limited to the orders shown for performing the operations by the respective blocks. In portions of the following discussion, reference may be made to the environment 100 of FIG. 1 and the examples of FIGS. 2A, 2B, 2C, 3A, and 3B. By way of example, aspects of the procedures may be performed by a suitably configured computing device, such as by a computing device 102 as in FIG. 1 that includes or makes use of a sharing module 104, communication transports 106, an operating system 116, and/or other components.

FIG. 2 is a flow diagram depicting an example procedure 200 for recipient-based content sharing in accordance with one or more implementations.

At 202, input is received to share content with a recipient. For example, sharing module 104 receives user input to share content 108 with a recipient 110. As described herein, sharing content with a recipient may include sharing content with a single recipient, or a group of recipients. For example, the user may provide input to share content with the user's mom, or to share content with a group of “college friends” that includes multiple recipients. The user input can be received in a variety of different ways, for example the user input can be received responsive to selection of a control to share content, such as a photo, video, or document, with a particular recipient. Notably, the user input can be received independent of the user selecting a particular type of communication transport 106 to use. For example, instead of opening up an email application, and then selecting a recipient to communicate with via the email application, the user input may correspond to a request to share content with a particular recipient, such as the user's mom, friend, or sibling, without a specific request to use a particular communication transport.

In one or more implementations, in response to receiving the input to share content 108, sharing module 104 suggests one or more important or relevant recipients. Sharing module 104 may determine the important or relevant recipients in a variety of different ways. For instance, the recipients may correspond to people that the user frequently communicates with using communication transports 106, or people that the user has most-recently communicated with using communication transports 106 (e.g., the last 4 people that the user communicated with using a communication transport). In one or more implementations, the important or relevant recipients may correspond to people that are associated with the content. For example, the important or relevant recipients may correspond to people whose faces are recognized in a photo or video using facial recognition technology. As another example, the important or relevant recipients may correspond to people whose names are recognized in a document. Alternately, the important or relevant recipients may be selected by the user. For example, the user may select important recipients, such as parents, a brother, or a spouse.

Sharing module 104 may cause display of sharing user interface 112 which includes representations of the one or more important or relevant recipients. Doing so enables the user to select one of the recipients 110 to share the particular content 108 with the selected recipient.

As an example, consider FIG. 3A, which illustrates an example 300 of recipient-based content sharing in accordance with one or more implementations. In FIG. 3A, a web browser 302 displays a news article 304 titled “Seahawks Win Super Bowl”. In response to user input to share the article (e.g., via a share control which is not pictured), sharing module 104 causes display of sharing user interface 112. In this example, sharing user interface presents a list of selectable representations of important or relevant recipients, which includes Jack, Eric, Wyatt, and John. As noted above, the recipients presented in the sharing user interface 112 may be determined in a variety of different ways. Of course, the number of recipients presented in the sharing user interface 112 may vary. In this case, the sharing user interface 112 enables the user to select “More People” in order to view additional recipients.

Optionally, the sharing user interface 112 may also present a list of communication transports 106. In example 300 the sharing user interface displays indicators for Facebook, Skype, and Mail. Doing so enables the user to share the content with a particular recipient, or via a particular communication transport 106.

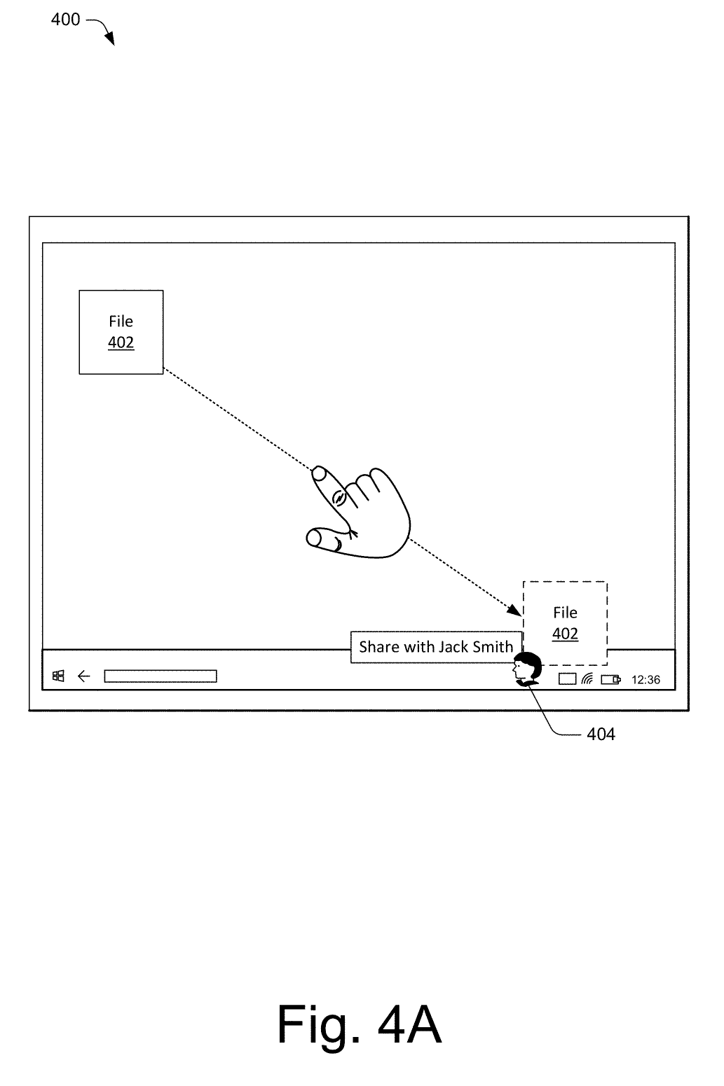

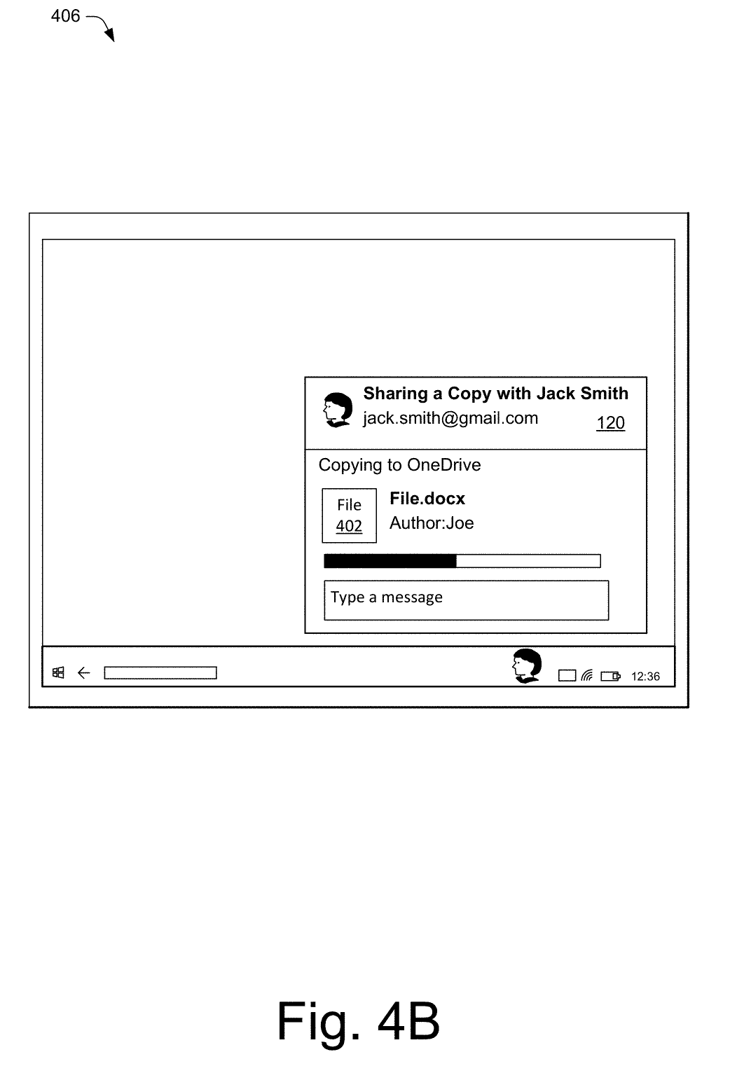

In one or more implementations, the input to share the content may be received via a “drag and drop” operation, in which the user selects content 108 (e.g., using a mouse or the user's finger) and drags the content proximate a visual representation of the recipient. Consider, for example, FIG. 4A which illustrates an additional example 400 of recipient-based content sharing in accordance with one or more implementations.

In FIG. 4A, a file 402 is presented on the home screen of computing device 102. File 402 may correspond to any type of file, such as a photo, video, document, and so forth. The user selects file 402 (e.g., with the user's finger or a mouse), and drags file 402 to a visual representation 404 of a recipient. In response to the drag and drop operation, sharing module 104 causes display of sharing user interface 112 which indicates that the drag and drop operation will cause the content to be shared with a person named “Jack Smith”. In this example, visual representation 404 is displayed in a taskbar of the home screen. Notably, however, visual representation 404 may be displayed in a variety of different locations. For example, in some cases, visual representations of recipients may be displayed as tiles on a home screen of a smartphone. In addition, while just one visual representation is displayed in example, 400, in some cases multiple visual representations that each correspond to a different recipient may be displayed. In some cases, for example, the display may allow the user to pin different important recipients to a start screen.

At 204, a communication transport for communicating the content to the recipient is determined based at least in part on a history of sharing content with the recipient or a type of the content. For example, sharing module 104 determines a communication transport 106 for communicating content 108 to the recipient selected by the user based at least in part on a history of sharing content with the recipient or a type of the content. In some cases, sharing module 104 selects the communication transport 106 based on other context data, such as a current time or location at which the input to share content is received.

In one or more implementations, sharing module 104 is configured to automatically determine the communication transport in response to the input to share the content. Consider, for example, FIG. 3B which illustrates an additional example 304 of recipient-based content sharing in accordance with one or more implementations. In this example, in response to the user input to share content with the recipient Jack, sharing module 104 automatically determines a communication transport 106, which in this example is Skype, for sharing the content 108. Then, sharing module 104 causes display of sharing user interface 112 which enables the user to simply type a skype message, or enter no message at all, and then select a “send” control to share the news article with Jack Smith via Skype.

Sharing module 104 can determine the appropriate communication transport 106 in a variety of different ways. In one or more implementations, sharing module 104 selects the communication transport 106 based on the “last-used” communication transport 106 (e.g., the communication transport 106 that was most-recently used to communicate content to the particular recipient). For instance, in example 304, Skype may be automatically selected by sharing module 104 because the last time that the user shared content with the Jack Smith it was via Skype.

Alternately or additionally, sharing module 104 selects the communication transport 106 based on the “most-frequently used” communication transport 106 (e.g., the communication transport 106 that is most-frequently used to communicate content to the particular recipient). For instance, in example 304, Skype may be automatically selected by sharing module 104 because the user most-frequently uses Skype to share content with Jack Smith.

Alternately or additionally, sharing module 104 selects the communication transport 106 based on a proximity of the device of the user to the recipient's device. For example, if a device of the user is within a particular proximity to a device of the recipient, then sharing module 104 may select a nearby device technology as the communication transport 106. Examples of nearby device technologies include Bluetooth®, Airdrop by Apple®, NFC, or any other type of other personal area network (PAN). In some cases, sharing module 104 may select the communication transport 106 based on the last-used and/or most frequently-used communication transport 106, unless the user is within the particular proximity to the recipient, in which case the proximity of the recipient overrides the default mode causing sharing module 104 to select the nearby device technology.

Alternately or additionally, sharing module 104 selects the communication transport 106 based on a determination that the recipient is currently using or “signed in” to the particular communication transport 106 or is “online”. For example, if the user is currently “signed in” to Facebook Messenger, then sharing module 104 may select Facebook Messenger as the communication transport 106 due to the fact that the user is likely to quickly view and or respond to the communication of content 108. In some cases, if it is determined that the recipient is “offline” or is not signed in to any communication transports, then a default communication transport may be selected. For example, if it is determined that the user is not signed in to any communication transports, then sharing module 104 may select an email application as the default communication transport.

Alternately or additionally, sharing module 104 selects the communication transport 106 based on the type of content 108 to be communicated. For example, sharing module 104 can determine whether the content 108 is personal content (e.g., photos of the user's family) or business-related content (e.g., a work-related document or spreadsheet). In this example, if the content is determined to be personal, then the data may be communicated via a personal transport, such as by communicating the content via text message or to the user's personal email account. Alternately, if the data is determined to be business-related content, then the content may be communicated via a business-related transport, such as by communicating the data to the user's “business” email address.

In one or more implementations, rather than automatically selecting a single communication transport 106 for the communication, sharing module 104 can determine a list of suggested communication transports 106 that can be used to share the content 108 with the recipient 110. Sharing module 104 may determine the list of suggested communication transports 106 using any one, or a combination, of the above-noted criteria, such as the last-used communication transport, the frequency of use of each communication transport, the proximity to the user, and so forth. The list may inform the user which communication transports 106 are available and/or effective for communicating with the recipient 110. For example, the list may include all of the available communication transports 106 which may be used to communicate with the recipient 110, as well as an indication as to which transport would be most effective for sharing the content 108. Sharing module 104 can present the list of recommended communication transports in sharing user interface 112 to enable the user to select one of the communication transports in the list to share content 108 with the recipient 110.

Consider for example, FIG. 3C which illustrates an additional example 306 of recipient-based content sharing in accordance with one or more implementations. In this example, rather than automatically selecting a particular communication transport 106, sharing module 104 determines a list of recommend communication transports 106 for sharing content 108 with the recipient 110, and presents the list in sharing user interface 112. In some cases, the list is ordered such that the communication transport at the top of the list corresponds to the “best” or most-appropriate communication protocol. This can be determined in a variety of different ways, such as based on any one or a combination of the last-used communication protocol, the frequency of use, or the proximity of the user. In FIG. 3C, for instance, Skype is presented at the top of the list which indicates that Skype is the best communication protocol for communicating the content to the recipient 110. Of course, the user may select a different one of the protocols for a variety of different reasons.

At 206, the content is shared with the recipient using the determined communication transport. For example, sharing module 104 shares content 108 with recipient 110 using the determined communication transport 106, such as by communicating the content 108 to the recipient using email, Facebook, Skype, text messaging, a device-sharing transport (e.g., nearby device technology), and so forth.

In one or more implementations, rather than communicating the content 108 directly to the recipient 110 using the determined communication transport 106, sharing module 104 shares the content 108 by first uploading the content 108 to file-sharing service 114, such as Microsoft OneDrive or Dropbox. Then, sharing module 104 shares a link to the content 108, stored at the file-sharing service 114, with the recipient 110 via the communication transport 106. The recipient may then access the content 108 by selecting the link to download the content 108 from the file-sharing service 114.

In some cases, sharing module 104 may be configured to automatically upload the content 108 to file-sharing service 114 each time that the user shares content with a recipient. Alternately, sharing module 104 may determine whether a size of the content 108 prevents the content from being communicated to the user via the determined communication transport 106. If the content is too large for the determined communication transport 106, then sharing module 104 uploads the content to the file-sharing service 114 and shares the link via the communication transport. For example, some email applications may have a restriction on the size of content that can be attached to an email application. Thus, in order to transfer a large file to the recipient (e.g., a large video file), the content is uploaded to file-sharing service 114, and a link is communicated to the recipient as an email message. The recipient can then download the content 108 by selecting the link contained in the email message. In some cases the link may be a secure permissioned link that prevents unauthorized recipients from downloading the content 108.

In some cases, sharing module 104 may determine a type of the file-sharing service 114 to utilize based on the type of the content. For example, business-related content (e.g., work documents) may be uploaded to a “business” file-sharing service 114, whereas personal content (e.g., photos) may be uploaded to a “personal” file-sharing service 114. For instance, a user may use the file-sharing service Microsoft OneDrive® for business content, and use the file-sharing service Dropbox® for personal content.

FIG. 4B illustrates an additional example 406 of recipient-based content sharing in accordance with one or more implementations. In this example, after selecting the recipient Jack Smith by dragging and dropping file 402 to the visual representation 404 of Jack Smith (illustrated in FIG. 4A), sharing module 104 uploads the file 402 to the file-sharing service OneDrive. In this example, sharing module 104 presents an upload status in sharing user interface 112 which indicates that file 402 is being uploaded to OneDrive. Once the upload is complete, an email message, that contains a link to file 402 stored at OneDrive, will be communicated to the email address of Jack Smith, who can then download file 402 via selection of the link contained in the email message.

In one or more implementations, module 104 receives a share completion event that indicates the success or failure of sharing the content 108 with the recipient. The share completion event enables sharing module 104 to create summaries of shared content to specific individuals or groups. These summaries can then be presented to the user via sharing user interface 112. For example, the user could type the name “Jack Smith” into the sharing user interface 112 to view a list of everything that the user has previously shared with Jack Smith, as well as the communication transport 106 that was used to share each piece of content. The user could also, for example, see a list of each content item shared with a particular communication protocol, such as a list of all of the content previously shared with Jack Smith via Skype. In addition, the name of the recipient can be used as metadata to locate the content. For example, if content is shared with “Bob”, the user can type the name “Bob” into a search control of sharing user interface 112 in order to locate the content.

### Example System and Device

FIG. 5 illustrates an example system generally at 500 that includes an example computing device 502 that is representative of one or more computing systems and/or devices that may implement the various techniques described herein. The computing device 502 may be, for example, a server of a service provider, a device associated with the client (e.g., a client device), an on-chip system, and/or any other suitable computing device or computing system.

The example computing device 502 as illustrated includes a processing system 504, one or more computer-readable media 506, and one or more I/O interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Thus, computer-readable storage media does not include signal bearing media or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to a signal-bearing medium that is configured to transmit instructions to the hardware of the computing device 502, such as via a network. Communication media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including operating system 116, recipient-based sharing module 104, communication transports 106 and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 502 may assume a variety of different configurations, such as for computer 514, mobile 516, and television 518 uses. Each of these configurations includes devices that may have generally different constructs and capabilities, and thus the computing device 502 may be configured according to one or more of the different device classes. For instance, the computing device 502 may be implemented as the computer 514 class of a device that includes a personal computer, desktop computer, a multi-screen computer, laptop computer, netbook, and so on.

The computing device 502 may also be implemented as the mobile 516 class of device that includes mobile devices, such as a mobile phone, portable music player, portable gaming device, a tablet computer, a multi-screen computer, and so on. The computing device 502 may also be implemented as the television 518 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This is illustrated through inclusion of the application manager 128 on the computing device 502. The functionality of the application manager 128 and other modules may also be implemented all or in part through use of a distributed system, such as over a “cloud” 520 via a platform 522 as described below.

The cloud 520 includes and/or is representative of a platform 522 for resources 524. The platform 522 abstracts underlying functionality of hardware (e.g., servers) and software resources of the cloud 520. The resources 524 may include applications and/or data that can be utilized while computer processing is executed on servers that are remote from the computing device 502. Resources 524 can also include services provided over the Internet and/or through a subscriber network, such as a cellular or Wi-Fi network.

The platform 522 may abstract resources and functions to connect the computing device 502 with other computing devices. The platform 522 may also serve to abstract scaling of resources to provide a corresponding level of scale to encountered demand for the resources 524 that are implemented via the platform 522. Accordingly, in an interconnected device embodiment, implementation of functionality described herein may be distributed throughout the system 500. For example, the functionality may be implemented in part on the computing device 502 as well as via the platform 522 that abstracts the functionality of the cloud 520.

### Conclusion and Example Implementations

Example implementations described herein include, but are not limited to, one or any combinations of one or more of the following examples:

A computer-implemented method comprising: detecting input to share content with a recipient; determining a communication transport for sharing the content with the recipient based at least on part on a history of sharing content with the recipient or a type of the content; and sharing the content with the recipient using the determined communication transport.

A computer-implemented method as described above, wherein the sharing the content with the recipient further comprises: uploading the content to a remote file-sharing service; and sharing a link to the content stored at the file-sharing service with the recipient via the determined communication transport, the link selectable to download the content.

A computer-implemented method as described above, wherein the uploading the content to the remote-file sharing service is performed in response to determining that a size of the content prevents the content from being shared with the recipient via the determined communication transport.

A computer-implemented method as described above, further comprising: determining a type of the content; and selecting a type of the remote-file sharing service based on a type of the content.

A computer-implemented method as described above, wherein the sharing the content with the recipient further comprises communicating the content directly to the recipient using the communication transport.

A computer-implemented method as described above, wherein the determining the communication transport comprises automatically selecting the communication transport based on the communication transport being the last-used communication transport to share content with the recipient.

A computer-implemented method as described above, wherein the determining the communication transport comprises automatically selecting the communication transport based on the communication transport being the most frequently used communication transport to share content with the recipient.

A computer-implemented method as described above, wherein the determining the communication transport comprises automatically selecting a nearby device technology to share the content based on a device of the recipient being within proximity such that the content can be communicated to the device of the recipient using the nearby device technology.

A computer-implemented method as described above, wherein the determining the communication transport comprises automatically selecting the communication transport based on the type of the content.

A computer-implemented method as described above, wherein the determining the communication transport comprises automatically selecting the communication transport based on whether the user is online or currently using or signed in to the communication transport.

A computer-implemented method as described above, wherein the determining communication transport comprises determining a suggested list of communication transports that have been previously used to share content with the recipient; presenting the suggested list of communication transports in a sharing user interface, the communication transports in the suggested list ordered based on one or more of how recently each respective communication transport was used to share content with the recipient, how frequently each respective communication transport is used to share content with the recipient, or a proximity of the recipient; and receiving a selection of the communication transport from the suggested list of communication transports.

A computer-implemented method as described above, further comprising: receiving a share completion event indicating a success or failure of sharing the content with the recipient; and using the share completion event to create a summary of shared content with specific recipients or groups.

A computer-implemented method as described above, wherein the input comprises input to drag and drop a visual representation of the content displayed in a user interface proximate a visual representation of the recipient displayed in the user interface.

A system comprising: a processing system; one or more computer-readable media storing processor-executable instructions that, responsive to execution by the processing system, implement a recipient-based sharing module configured to perform operations comprising: detecting input to drag a visual representation of content displayed in a user interface proximate a visual representation of a recipient displayed in the user interface; automatically determining a communication transport for sharing the content with the recipient; and sharing the content with the recipient using the determined communication transport.

A system as described above, wherein the recipient-based sharing module is configured to automatically determine the communication transport for sharing the content with the recipient based at least on part on a history of sharing content with the recipient or a type of the content.

A system as described above, wherein the recipient-based sharing module is configured to automatically determine the communication transport without receiving input selecting the communication transport.

A system as described above, wherein the recipient-based sharing module is configured to automatically share the content with the recipient by: uploading the content to a remote file-sharing service; and sharing a link to the content stored at the file-sharing service with the recipient via the determined communication transport, the link selectable to download the content.

A system as described above, wherein the recipient-based sharing module is configured to share the content by communicating the content directly to the recipient using the communication transport.

One or more computer-readable storage media storing processor-executable instructions that, responsive to execution by a processing system of a computing device, implement an operating system to perform operations comprising: detecting input to share content with a recipient; determining a communication transport for sharing the content with the recipient; and sharing the content with the recipient using the determined communication transport by: uploading the content to a remote file-sharing service; and sharing a link to the content stored at the file-sharing service with the recipient via the determined communication transport, the link selectable to download the content.

One or more computer-readable storage media as described above, wherein the uploading the content to the remote-file sharing service is performed in response to determining that a size of the content prevents the content from being shared with the recipient directly via the determined communication transport.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A computer-implemented method comprising:
detecting input to share content with a recipient;
determining a communication transport for sharing the content with the recipient based at least on part on a history of sharing content with the recipient or a type of the content; and
sharing the content with the recipient using the determined communication transport.

2. The computer-implemented method as described in claim 1, wherein the sharing the content with the recipient further comprises:
uploading the content to a remote file-sharing service; and
sharing a link to the content stored at the file-sharing service with the recipient via the determined communication transport, the link selectable to download the content.

3. The computer-implemented method as described in claim 2, wherein the uploading the content to the remote-file sharing service is performed in response to determining that a size of the content prevents the content from being shared with the recipient via the determined communication transport.

4. The computer-implemented method as described in claim 2, further comprising:
determining a type of the content; and
selecting a type of the remote-file sharing service based on a type of the content.

5. The computer-implemented method as described in claim 1, wherein the sharing the content with the recipient further comprises communicating the content directly to the recipient using the communication transport.

6. The computer-implemented method as described in claim 1, wherein the determining the communication transport comprises automatically selecting the communication transport based on the communication transport being the last-used communication transport to share content with the recipient.

7. The computer-implemented method as described in claim 1, wherein the determining the communication transport comprises automatically selecting the communication transport based on the communication transport being the most frequently used communication transport to share content with the recipient.

8. The computer-implemented method as described in claim 1, wherein the determining the communication transport comprises automatically selecting a nearby device technology to share the content based on a device of the recipient being within proximity such that the content can be communicated to the device of the recipient using the nearby device technology.

9. The computer-implemented method as described in claim 1, wherein the determining the communication transport comprises automatically selecting the communication transport based on the type of the content.

10. The computer-implemented method as described in claim 1, wherein the determining the communication transport comprises automatically selecting the communication transport based on whether the user is online or currently using or signed in to the communication transport.

11. The computer-implemented method as described in claim 1, wherein the determining communication transport comprises determining a suggested list of communication transports that have been previously used to share content with the recipient;
presenting the suggested list of communication transports in a sharing user interface, the communication transports in the suggested list ordered based on one or more of how recently each respective communication transport was used to share content with the recipient, how frequently each respective communication transport is used to share content with the recipient, or a proximity of the recipient; and
receiving a selection of the communication transport from the suggested list of communication transports.

12. The computer-implemented method as described in claim 1, further comprising:
receiving a share completion event indicating a success or failure of sharing the content with the recipient; and
using the share completion event to create a summary of shared content with specific recipients or groups.

13. The computer-implemented method as described in claim 1, wherein the input comprises input to drag and drop a visual representation of the content displayed in a user interface proximate a visual representation of the recipient displayed in the user interface.

14. A system comprising:
a processing system;
one or more computer-readable media storing processor-executable instructions that, responsive to execution by the processing system, implement a recipient-based sharing module configured to perform operations comprising:
detecting input to drag a visual representation of content displayed in a user interface proximate a visual representation of a recipient displayed in the user interface;
automatically determining a communication transport for sharing the content with the recipient; and
sharing the content with the recipient using the determined communication transport.

15. The system as described in claim 14, wherein the recipient-based sharing module is configured to automatically determine the communication transport for sharing the content with the recipient based at least on part on a history of sharing content with the recipient or a type of the content.

16. The system as described in claim 14, wherein the recipient-based sharing module is configured to automatically determine the communication transport without receiving input selecting the communication transport.

17. The system as described in claim 14, wherein the recipient-based sharing module is configured to automatically share the content with the recipient by:
uploading the content to a remote file-sharing service; and
sharing a link to the content stored at the file-sharing service with the recipient via the determined communication transport, the link selectable to download the content.

18. The system as described in claim 14, wherein the recipient-based sharing module is configured to share the content by communicating the content directly to the recipient using the communication transport.

19. One or more computer-readable storage media storing processor-executable instructions that, responsive to execution by a processing system of a computing device, implement an operating system to perform operations comprising:
detecting input to share content with a recipient;
determining a communication transport for sharing the content with the recipient; and
sharing the content with the recipient using the determined communication transport by:
uploading the content to a remote file-sharing service; and
sharing a link to the content stored at the file-sharing service with the recipient via the determined communication transport, the link selectable to download the content.

20. The one or more computer-readable storage media as described in claim 19, wherein the uploading the content to the remote-file sharing service is performed in response to determining that a size of the content prevents the content from being shared with the recipient directly via the determined communication transport.
